(19) United States
(12) Patent Application Publication
(10) Pub. No.: US 2024/0378393 A1
(43) Pub. Date: Nov. 14, 2024

(54) Virtual Agent Generation Based on Historical Conversation Data

(71) Applicant: ServiceNow, Inc., Santa Clara, CA (US)

(72) Inventors: Amine El Hattami, Montreal (CA); Christopher Pal, Montreal (CA); Amit Srivastava, Santa Clara, CA (US)

(21) Appl. No.: 18/195,706

(22) Filed: May 10, 2023

(51) Int. Cl. G06F 40/40; H04L 51/02

(52) U.S. Cl. CPC G06F 40/40; H04L 51/02

(57) ABSTRACT

An example embodiment may involve obtaining a chat dialog including a first question and a first action; obtaining, from a natural language model, an utterance based on the first question and an input parameter associated with the utterance; obtaining, from the natural language model, program code for performing the first action on a computing system, wherein the program code is based on a textual description of the first action and specification of a variable defined by the computing system in which to store the input parameter; and generating a virtual agent to perform the first action on the computing system using the program code.

### BACKGROUND

A virtual agent or digital assistant, such as a chatbot, is a type of a software application that can facilitate an online conversation. In some cases, the virtual agent facilitates the conversation via natural language processing or text-to-speech processing. A virtual agent typically follows predefined rules (e.g., dialog trees and/or other structures) that map inputs (and/or the predicted semantic intent thereof) to outputs. An example of a recent machine learning advance in natural language processing is the usage of large language models (LLMs). However, because a virtual agent typically relies on predefined rules, the virtual agent often cannot efficiently or effectively utilize an LLM. For example, the virtual agent may be trained on a wide range of text from the Internet, and training via these sources often produces output that lacks explainability, contains inaccuracies, and can be offensive.

### SUMMARY

The embodiments herein overcome various limitations of other techniques by using advanced natural language models (such as LLMs) to generate rule-based virtual agents from historical conversation data. In other words, the input to these embodiments includes historical conversation data and the output is one or more rule-based virtual agents. Doing so may involve two main steps: (i) clustering and topic extraction from the historical conversation data, and (ii) virtual agent rule generation. Since the generated virtual agents follow rules that are based on actual conversations and the LLMs are used in a narrowly-tailored manner, virtual agent output is explainable, unlikely to be inaccurate, and unlikely to be offensive.

Accordingly, a first example embodiment may involve obtaining a chat dialog including a first question and a first action; obtaining, from a natural language model, an utterance based on the first question and an input parameter associated with the utterance; obtaining, from the natural language model, program code for performing the first action on a computing system, wherein the program code is based on a textual description of the first action and specification of a variable defined by the computing system in which to store the input parameter; and generating a virtual agent to perform the first action on the computing system using the program code.

A second example embodiment may involve a non-transitory computer-readable medium, having stored thereon program instructions that, upon execution by a computing system, cause the computing system to perform operations in accordance with the first example embodiment.

In a third example embodiment, a computing system may include at least one processor, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts deriving chat topic summaries from historical conversation data, in accordance with example embodiments.

FIG. 7A depicts using a natural language model to generate topics of chats, in accordance with example embodiments.

FIGS. 7B and 7C depict using a natural language model to generate and label a series of questions and actions from a chat, in accordance with example embodiments.

FIG. 8 depicts generating virtual agent rules from a chat topic summary, in accordance with example embodiments.

FIG. 9A depicts generating a virtual agent utterance, in accordance with example embodiments.

FIGS. 9B and 9C depict identification of user input parameters from virtual agent question text, in accordance with example embodiments.

FIG. 9D depicts summarization of virtual agent question text, in accordance with example embodiments.

FIGS. 10A and 10B depict code generation from a model prompt specifying predefined variables, in accordance with example embodiments.

FIG. 11 is a message flow diagram, in accordance with example embodiments.

FIG. 12 depicts a relationship between components, in accordance with example embodiments.

FIG. 13 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of predefined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

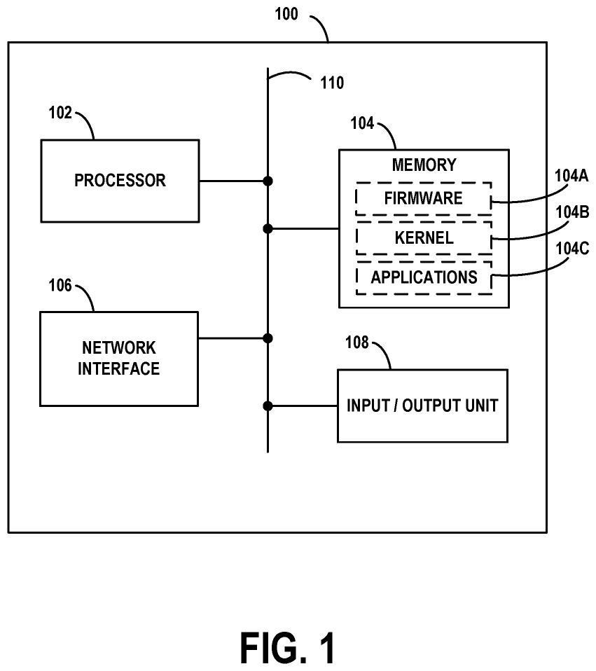

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

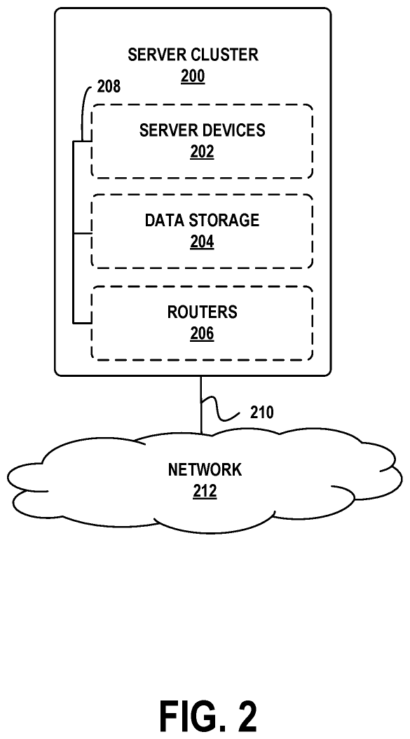

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

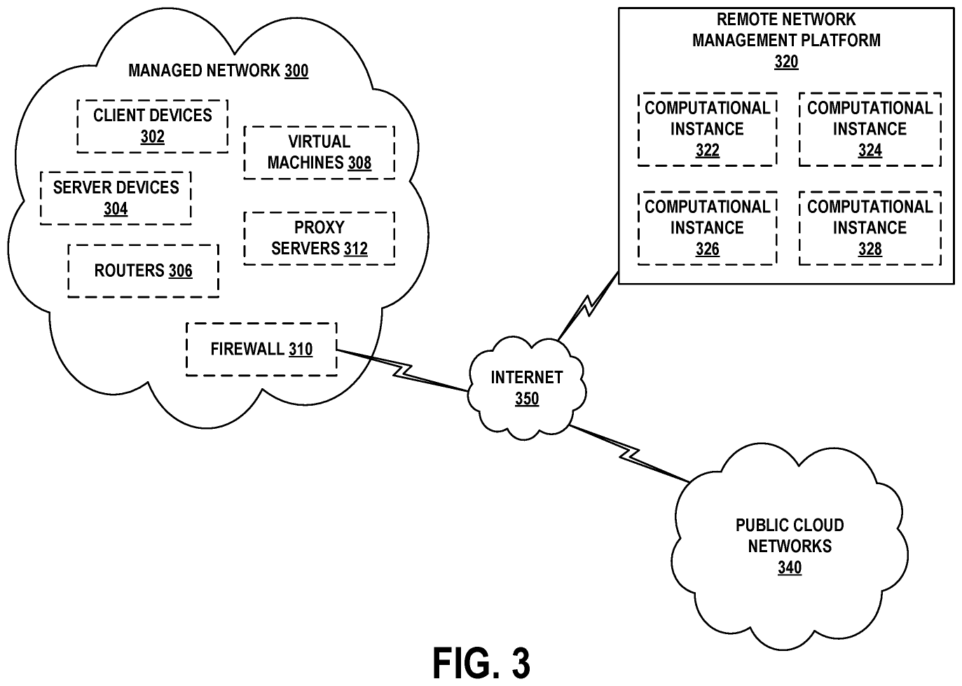

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

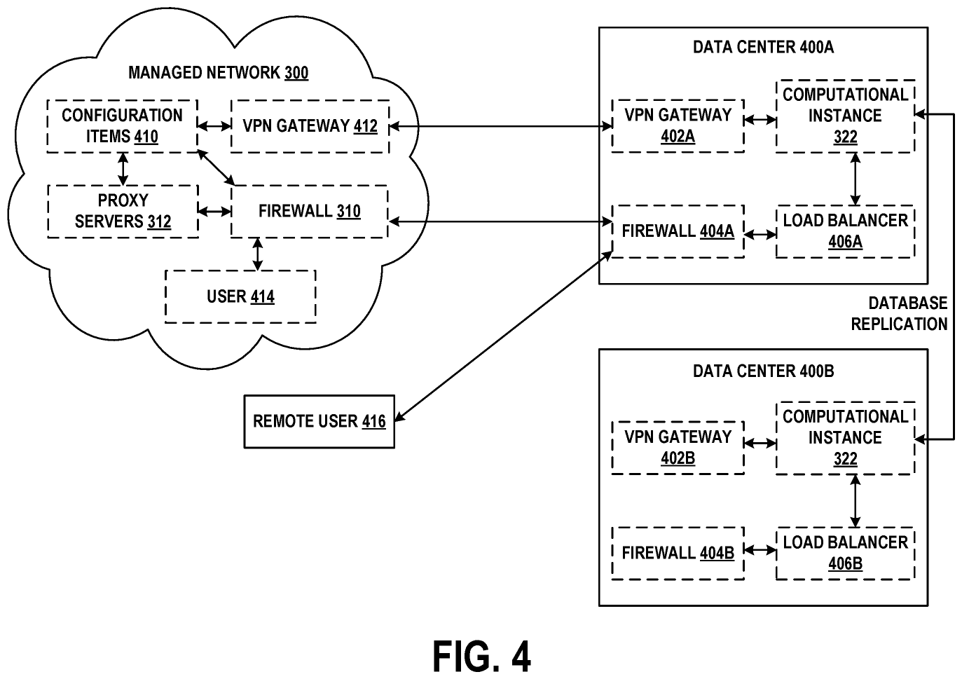

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

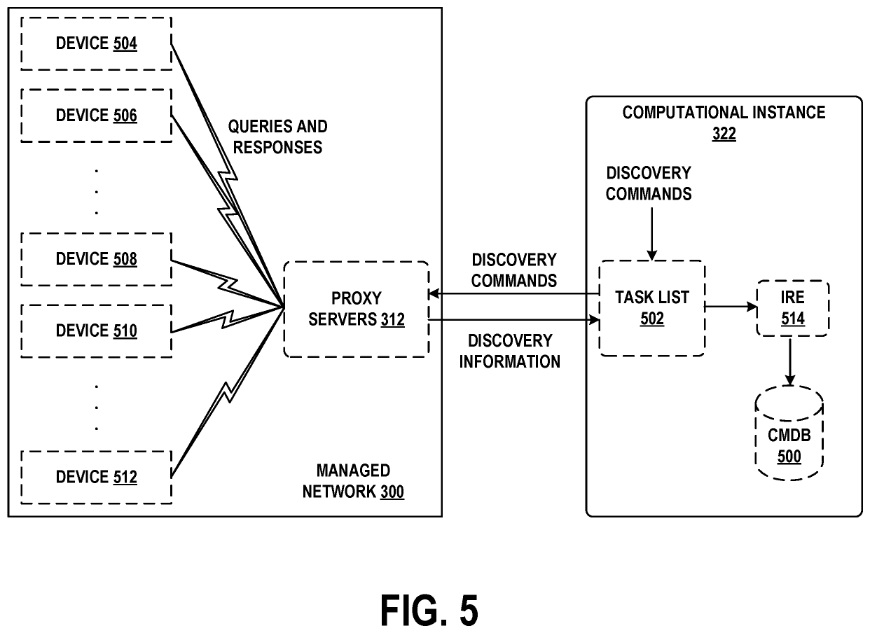

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rule-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Virtual Agent Generation Based Historical Conversation Data

As noted above, a virtual agent is a type of a software application used to carry out online conversations in natural language via text or text-to-speech. Sometimes virtual agents are also referred to as chatbots or digital assistants. Virtual agents can be deployed as part of or in conjunction with various applications operable on a remote network management platform, such as customer service, case management, and/or incident management applications. Alternatively or additionally, virtual agents may be deployed in a managed network or in a public cloud network.

In general, rule-based virtual agents present a user with a series of options for each unit of dialog (e.g., a question or statement from the virtual agent), and the user responds by picking one of the options. Alternatively, the virtual agent may ask the user a more open-ended question or make a more open-ended statement that can be responded to in natural language. Sequences of rules can be chained together or otherwise ordered to construct a dialog tree with branching pathways and cycles. In some cases, rule-based virtual agents may use sentiment analysis, named entity recognition, keywords, and/or emotion detection to determine which options to present to a user and how to interpret user input.

Herein, virtual agent “rules” refer at least to questions asked by the virtual agent, statements made by the virtual agent, how information received from a user is processed, the progression of the virtual agent through a dialog, and other actions that a virtual agent can take. Note that virtual agent rules are different from matching and reconciliation rules performed by IRE 514.

As an example, an IT virtual agent may first ask the user what type of problem they are experiencing. The virtual agent may be programmed with rules related to problems with voicemail, web browsers, powering a device, or passwords. If the user inputs that they are experiencing a problem with powering a device, the virtual agent may select a rule that asks the user what type of problem relating to powering a device that are experiencing. The virtual agent may be programmed with further rules related to problems with batteries, charging, and powering on a device. On the other hand, if the user inputs that they are experiencing a problem with a password, the virtual agent may select a rule that attempts to determine the system on which the problem is occurring and may provide the user with instructions for resetting their password.

Traditionally, virtual agents are designed and programmed with extensive manual effort, mainly to define rules (e.g., dialog trees and/or other structures) that the virtual agent will follow. This effort is typically virtual-agent-specific, in that different subject matter expertise is required to design and program different virtual agents with different uses. For instance, a customer support virtual agent for travel reservations would have different rules than a customer support virtual agent for IT troubleshooting. Likewise, a virtual agent for educational uses would have different rules than any customer support virtual agent.

These systems are limited by the inherent subjectivity of the design process when it is performed by humans. Designers of virtual agent rules and/or dialog trees might not have the requisite subject matter expertise in the area in which the virtual agent is intended to be used. As a result, different designers may produce rules and/or dialog trees of varying content and quality. This means that virtual agents can be deployed that have minimal or low efficacy (e.g., making common user requests require a large number of steps to carry out). Furthermore, manual design of virtual agent rules and/or dialog trees can be a time-consuming and expensive process.

Some attempts have been made to employ large language models (LLMs) to generate rule-based virtual agents. LLMs are machine-learning constructs that can be trained on vast amounts of textual data, such as books, articles, and websites, to learn patterns and relationships between words and phrases. Some examples of LLMs include GPT-4, bidirectional encoder representations from transformers (BERT), language model for dialogue applications (LaMDA), and Transformer-XL. LLMs can perform a wide range of natural language processing tasks, such as summarization, text classification, question answering, and language translation. These LLMs also have the ability to create coherent and human-like text. Many LLMs are based on the transformer architecture, which employs self-attention when considering different parts of an input sequence (e.g., of tokens such as words) to compute a representation of each element in the sequence taking long-range dependence between elements into account.

LLMs, however, suffer from significant drawbacks when used in their raw form. The output of an LLM lacks explainability. Their decision making processes are opaque and difficult to interpret as it is often based on a large number of weights feeding into layers of neural-network-based calculations. As a consequence, LLMs are known to “hallucinate” and generate text that is irrelevant, nonsensical, or even offensive. Thus, using LLMs in an off-the-shelf fashion to generate rule-based virtual agents is unlikely to be viable, and doing so may even be a liability.

The embodiments herein overcome these and potentially other drawbacks in current virtual agent design by employing natural language processing techniques (including LLM techniques) in a focused and controlled fashion to design rule-based virtual agents for various software applications. Advantageously, the design process is at least semi-automated and takes into consideration historical conversation data. Thus, virtual agents can be generated more rapidly, can utilize historical conversation data in development of their rules, and in doing so avoid the subjectivity and variability of manual design.

These embodiments may employ the following to two main steps: (i) clustering and topic extraction from the historical conversation data, and (ii) virtual agent rule generation. However, various sub-steps, alternative steps, and alternative orderings of steps and/or sub-steps may be used.

### VII. Clustering and Topic Extraction From Historical Conversation Data

Many organizations that currently use human agents or traditional virtual agents store records of conversations between these agents (or virtual agents) and users. These conversations may be text-based or in audio form. For purposes of simplicity, it will be assumed that this historical conversation data is entirely text-based. This can be accomplished by using speech-to-text conversion techniques to derive text data from audio files of spoken language, for example. It is not uncommon for thousands, tens of thousands, hundreds of thousands, or millions of such conversations to be stored, each including at least several units of dialog.

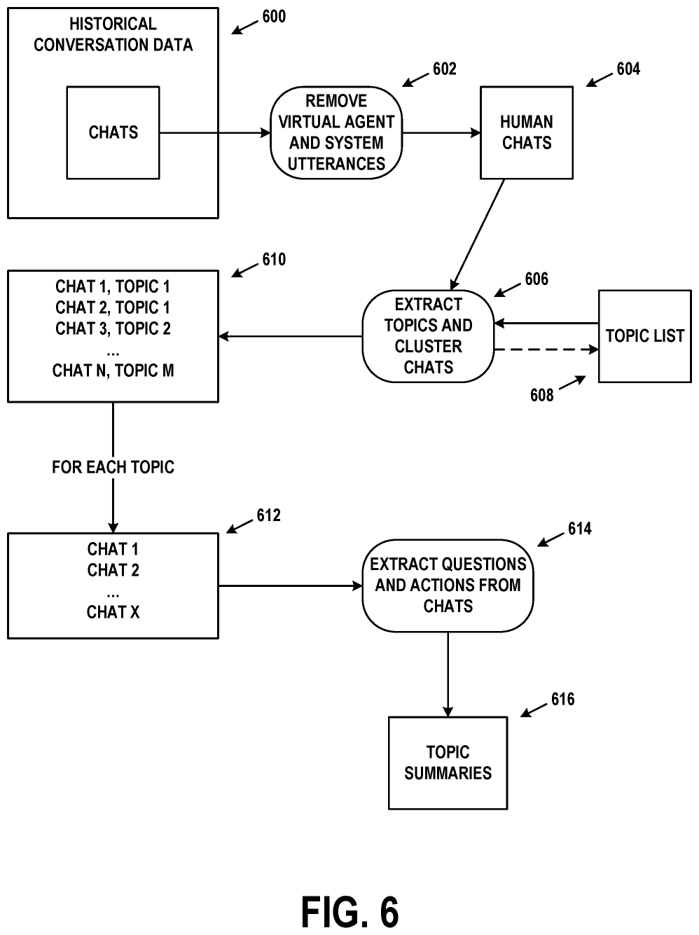

This first main step involves processing these historical conversation data into topics and then summaries of each topic, as depicted in FIG. 6. In this figure and certain other figures that follow, rectangular boxes generally represent data or states, whereas boxes with rounded corners generally represent processing sub-steps. Certain of these sub-steps may rely on LLM and/or non-LLM natural language technologies. Herein, these sub-steps may be said to be carried out by a “natural language model” such as an LLM or another type of model that performs similar natural language processing functionality.

Historical conversation data 600, as noted above, may include textual transcripts from a potentially extensive number of conversations, each conversation being referred to as a chat. In cases where historical conversation data 600 includes text generated by traditional virtual agents and/or system utterances, step 602 may be applied to filter these out, resulting in human chats 604. Thus, step 602 is optional and does not need to be used in all situations. This removal serves to focus the analysis of historical conversation data 600 (chats) on human-generated text. Thus, it eliminates bias that could be introduced by considering text generated by older virtual agents that use predefined rules exhibiting the aforementioned drawbacks and limitations. Moreover, eliminating machine-generated or system utterances that do not contribute to the content of the chat, such as “connecting you to a chat . . . ” or “please wait . . . ” focuses the process even further on the human-generated text.

Using human chats 604, step 606 extracts topics from each chat and clusters the chats based on their topics. In doing so, step 606 may use topic list 608 to determine the topics. Topic list 608 may include a number of predefined topics (e.g., in the case of an IT virtual agent, this could include topics of voicemail, web browsers, powering a device, or passwords). Further, step 606 may be configured to identify new topics from human chats 604 and add these to topic list 608 dynamically. Thus, in some cases, topic list 608 may start with just a few predefined topics or no predefined topics and then grow dynamically (as indicated by the dashed arrow from step 606 to topic list 608).

Notably, the clusters and clustering discussed in this and the following sections are different from the clusters of computing resources discussed in the context of FIGS. 2 and 3. Thus, the term “cluster” and related terms are intentionally overloaded herein, and the meanings of these terms should be interpreted based on how they are used.

An LLM may be used to perform this topic extraction. For instance, the LLM may be presented with part or all of each chat and a model prompt such as: “Use one or more of the following options to describe the topic of the chat, but if no topics are matches then generate a new topic. Options: voicemail, web browsers, powering a device, or passwords.” The LLM may select one of these topics or determine a new one in response. As topic list 608 grows, the topics listed in the model prompt may be expanded accordingly.

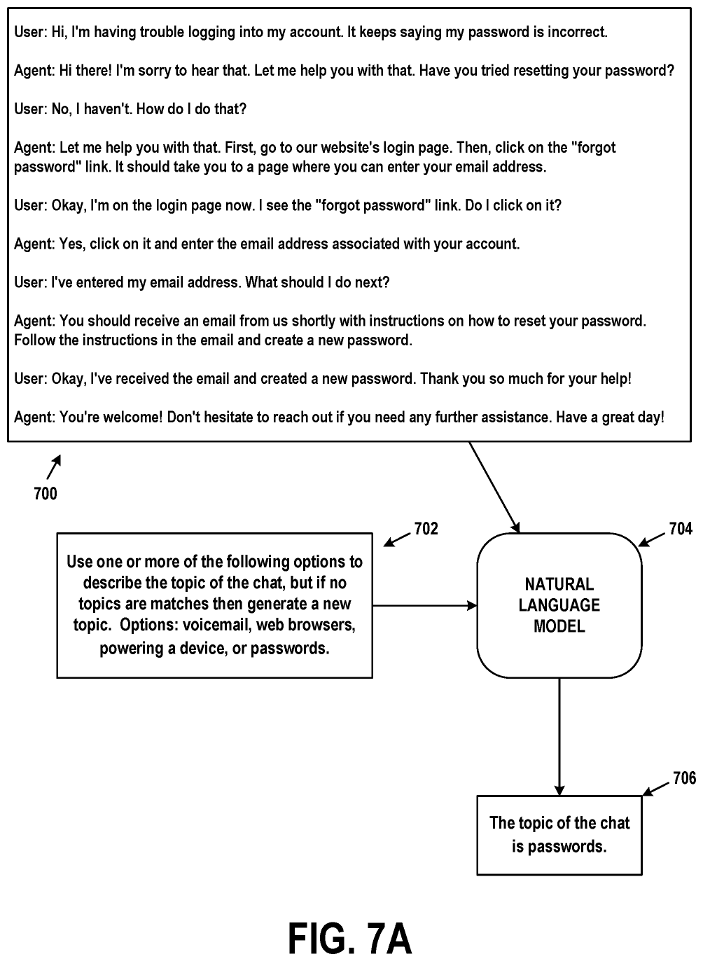

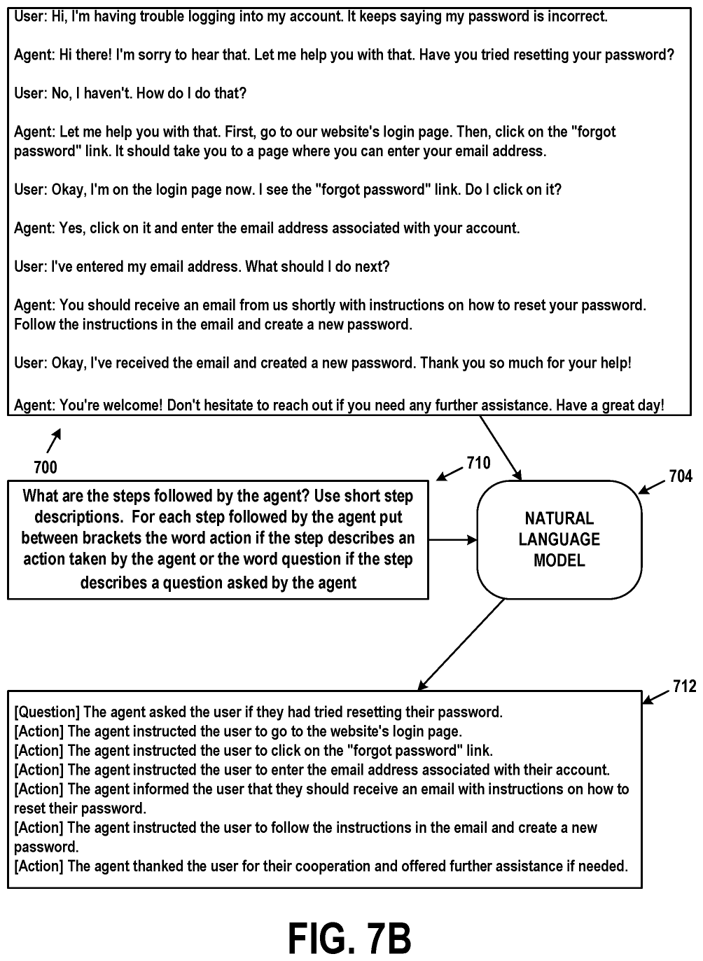

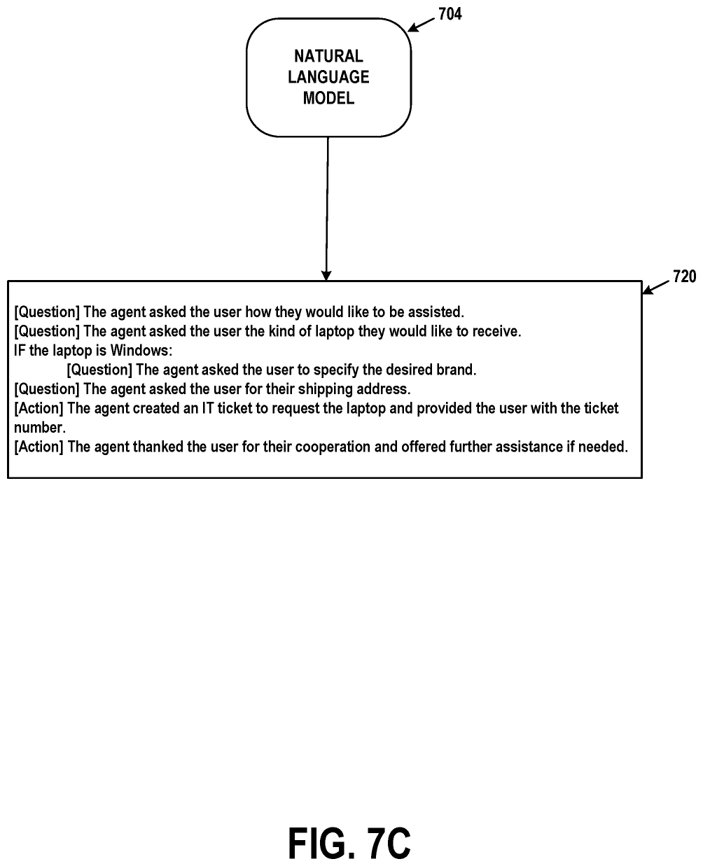

FIG. 7A provides an example of step 606 in practice. Chat 700 and model prompt 702 are provided to natural language model 704. Natural language model 704 may be an LLM (for the examples herein, GPT 3.5 was used). Regardless, natural language model 704 produces output 706, which indicates that the topic of the chat is passwords. Thus, simple parsing of output 706 can isolate the topic (passwords), which is then used to classify chat 700.

Nonetheless, other clustering techniques can be used in place of an LLM. For instance, techniques such as k-means (partitioning the chats into a predefined number of clusters based on their vectors, where each chat is assigned to the cluster with the nearest mean value), hierarchical modeling (building a tree-like structure of clusters, where chats are grouped together based on the similarity of their vectors), topic modeling (identifying the underlying topics or themes in the chats based on word distribution, for example, and grouping the chats into clusters accordingly), and/or spectral modeling (projecting the text of the chats into a high-dimensional space and then identifying clusters based on the similarity between chats in that space) may be used.

The results of performing step 606 on each of human chats 604 are classifications 610. Each of these classifications associates a chat from human chats 604 with a topic determined by step 606. Thus, as shown, there may be N chats each associated with one of M topics. It is expected that N>M in most cases. Further, variations of these embodiments (e.g., using a different model prompt) may associate at least some of the chats with more that one topic.

Classifications 610 can be used to identify, for each topic, a list of chats of that topic in per-topic chats 612. Once the chats are separated by topic, step 614 can be performed to extract the questions and actions of the agent (e.g., statement made or actions taken by the agent) from the chats of a given topic. This step is based on the observation that most text provided by the agent represents either a question to the user or an action that the agent performs.

FIG. 7B provides an example of step 614 in practice. Chat 700 and model prompt 710 are provided to natural language model 704. Natural language model 704 produces output 712, which labels each of the questions and actions of the agent from chat 700. In this example, there is just one question but more or fewer questions may be present. Further, a sequence of the questions and actions is also identified.

In some cases, a question or action may be conditioned on state information or other types of information. FIG. 7C provides an example in which natural language model 704 produces output 720. This output is a sequence of questions and actions of an agent who is assisting a user order a new laptop computer. Notably, if the user orders a Windows laptop, the agent conditionally asks the user for the brand.

From the aggregate of labeled outputs, like output 712, across a number of chats for the same topic, rules (e.g., a dialog tree) can be produced that can be used to control virtual agent behavior. Doing so is a goal of the next main step.

### VIII. Virtual Agent Rule Generation

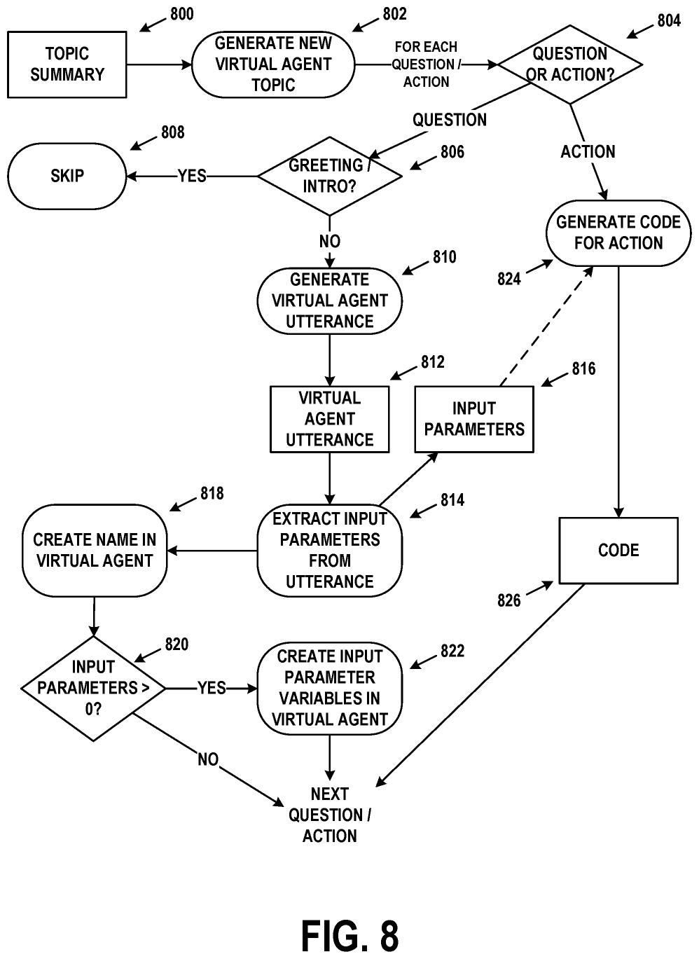

With labeled outputs derived from historical conversation data at hand, the second main step is to generate virtual agent rules. These rules may take the form of a sequence of units of dialog or a dialog tree for example. FIG. 8 depicts a process for doing so given a topic summary. In this figure, rectangular boxes generally represent data or states, boxes with rounded corners generally represent processing sub-steps, and diamonds indication decisions. Certain of the sub-steps may rely on LLM and/or non-LLM natural language technologies.

Topic summary 800 is one of topic summaries 616. It is assumed to include a canonical set of questions and actions for a given topic that is based on actual text from an agent appearing in historical conversation data. Step 802 generates a new virtual agent topic (e.g., an empty virtual agent dialog for the given topic). As indicated, the rest of the operations of FIG. 8 are carried out for each question and action of topic summary 800.

Step 804 determines whether the current unit of text in topic summary 800 is a question or an action. For example, this can be decided based on whether the line includes the token “[Question]” or the token “[Action]” as shown in FIG. 7B.

Assuming that a question is detected, step 806 determines whether the question is a greeting or an introduction. This step is optional and serves to identify certain non-substantive text that might appear in the historical conversation data, such as “Hello, how are you?” or “Please state your name.” Since such text may appear in canonical questions across many different topics, it adds little to generated virtual agent dialog and therefore can be skipped as indicated by step 808.

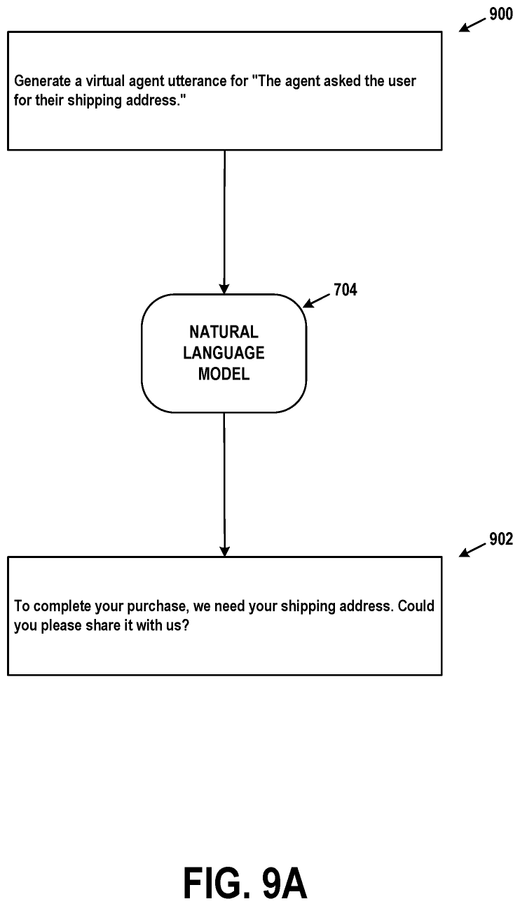

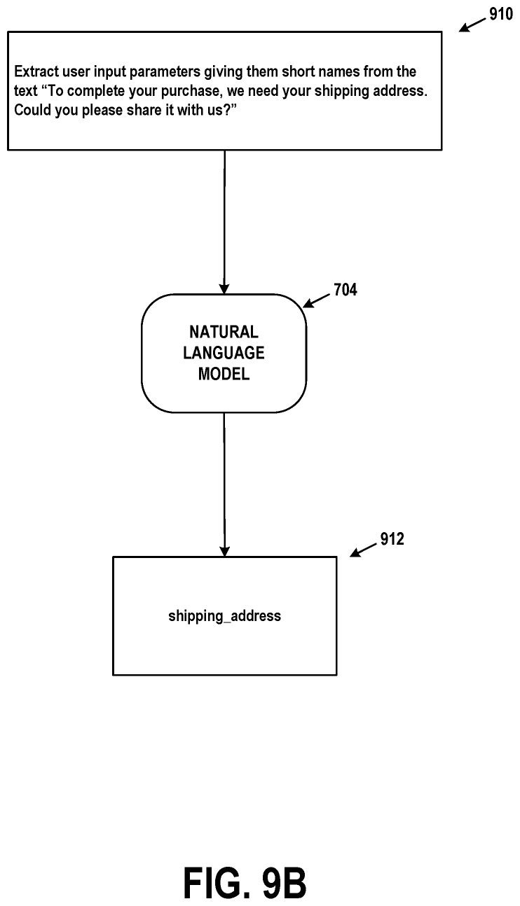

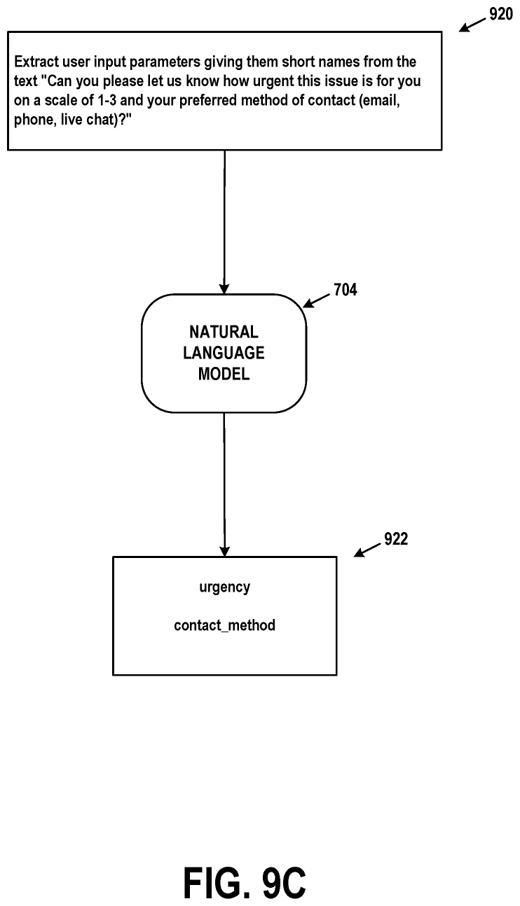

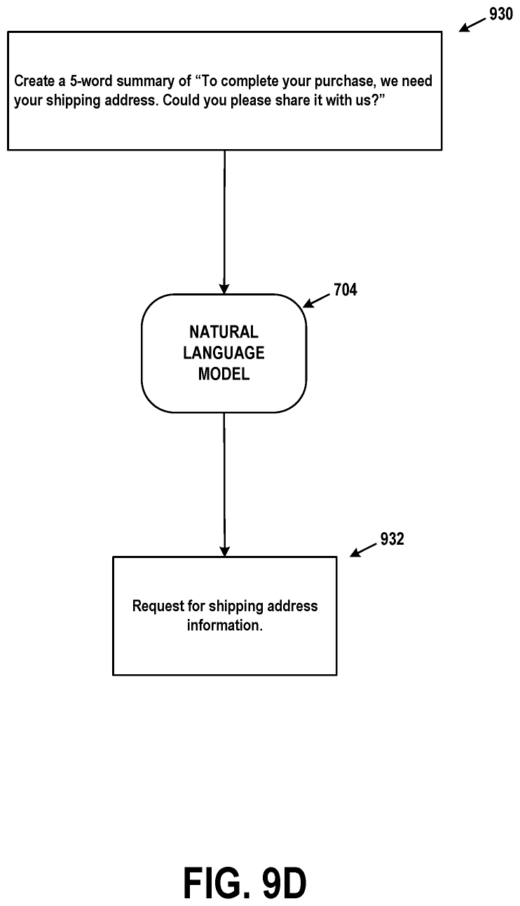

Otherwise, step 810 involves generating virtual agent utterance 812 based on the question. Doing so may involve presenting an LLM with a model prompt such as “Generate a chabot utterance for <question>”, where <question> is replaced by the question's text with the token “[Question]” removed. This is shown in FIG. 9A for one of the questions from output 720, where model prompt 900 is provided to natural language model 704 to produce utterance 902, “To complete your purchase, we need your shipping address. Could you please share it with us?” This utterance becomes virtual agent utterance 812 for this question and is then incorporated into the virtual agent rules.

Since virtual agent utterance 812 is a question that should be answered by a user, it is then processed in step 814 to extract the input parameter(s) therein. For purposes of these embodiments, an input parameter refers to input that the user is expected to provide in response to virtual agent utterance 812. As an example, if virtual agent utterance 812 requests the user's shipping address as described above, the input parameter will be for the user to enter their shipping address.

Step 814 may involve presenting an LLM with a model prompt such as “Extract user input parameters giving them short names from the text <utterance>”, where <utterance> is replaced by virtual agent utterance 812. This is shown in FIG. 9B for virtual agent utterance 812, where model prompt 910 is provided to natural language model 704 to produce the input parameter 912 named “shipping_address”. Input parameter 912 may be considered a variable name and is stored in input parameters 816. For sake of clarity, the variable named shipping_address is intended to store the input that the user enters in response to being asked for their shipping address by the virtual agent.

A compound question example is provided in FIG. 9C, where model prompt 920 with two embedded questions is provided to natural language model 704 to produce the input parameters 922 named “urgency” and “contact_method”. Each of input parameters 922 may be considered a variable name and is stored in input parameters 816.

Step 818 involves creating, in the virtual agent, a name for the question. This is an optional step that can be used to name the questions in the virtual agent flow so that they can be displayed visually (e.g., for descriptive or debugging purposes). An example is provided in FIG. 9D, where model prompt 930 is provided to natural language model 704 to produce the name 932. Here, natural language model 704 is asked to provide a 5-word summary of a question, but summaries of other lengths can be provided.

Step 820 involves determining whether any input parameters were created. If so, then step 822 involves creating associated variables in the virtual agent as well as any code needed to support the use of these variables. Once this process concludes (or if there were no input parameters created for the question), control passes to the next question or action in topic summary 800.

As noted, step 804 determines whether the current unit of text in topic summary 800 is a question or an action. Assuming that an action is detected, step 824 generates code 826 for the action, if applicable. This code may be in various programming languages and may be generated by an LLM, for example.

In some cases, code will not be generated for an action. For instance, if the action is an agent providing static information to the user, this can be represented in virtual agent text instead. But if the action is for the agent to change the state of a computing system or read from memory of long-term storage, and an API exists that supports automation of the these functions, code 826 may be generated for this purpose.

Further, part of step 824 may be for the system to search a library of code snippets for the desired code. This can be helpful if code for various common chat actions already exists and can be reused for this action as well. Doing do avoids the computational burden of generating new code. For instance, the text of the action may be used a search parameter for the library, and matching snippets may be returned.

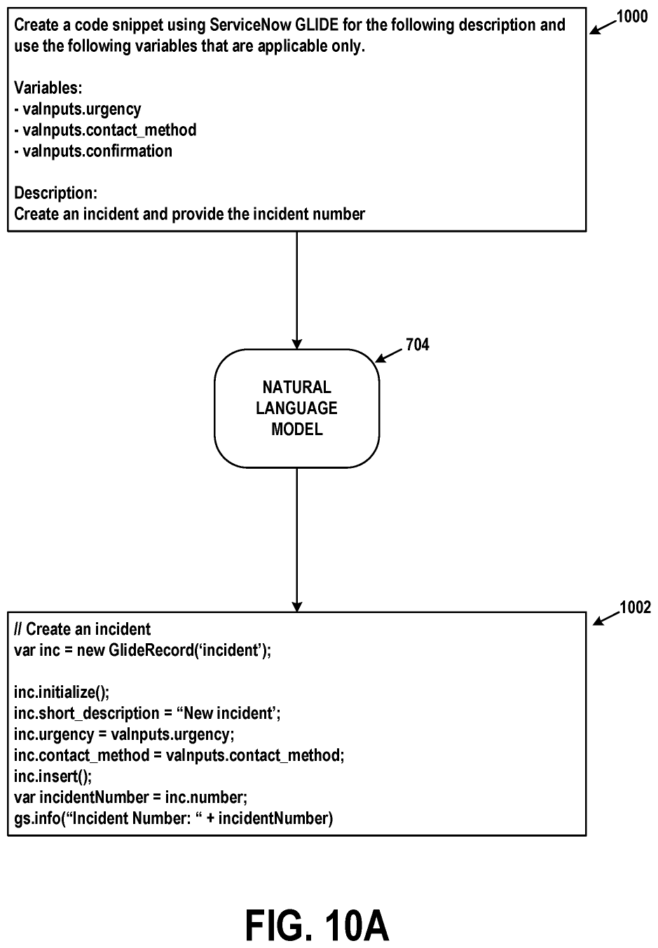

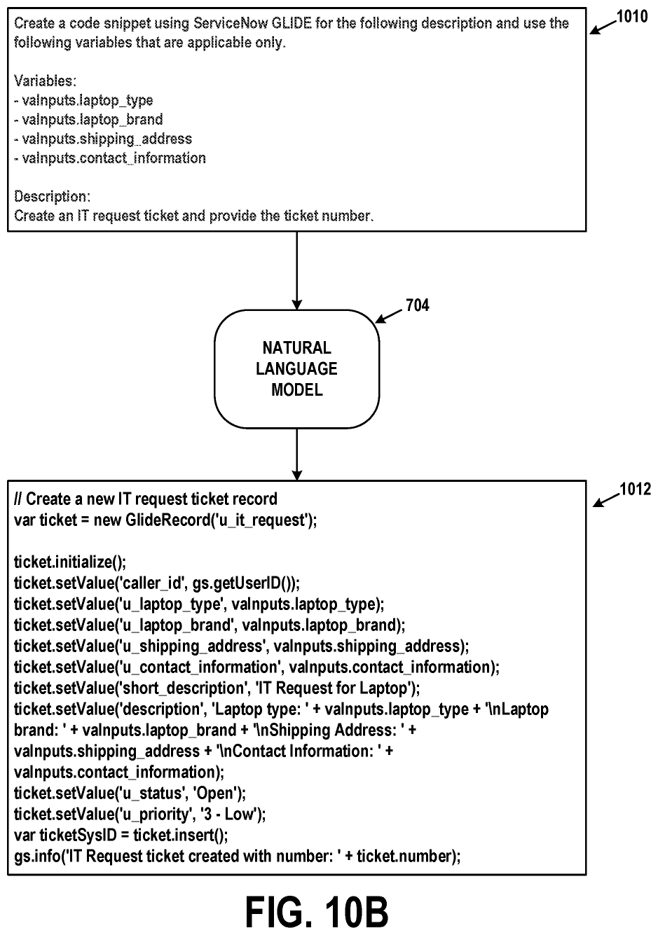

But if code 826 does need to be generated, an LLM can do so if provided with the proper model prompt. Examples that incorporate input parameters 816 are shown in FIGS. 10A and 10B.

In FIG. 10A, model prompt 1000 is provided to natural language model 704 to produce output 1002. Notably, model prompt 1000 requests code in the GLIDE programming language and identifies specific variable names to be used. Output 1002 includes code in GLIDE using variables with those names. This code can be executed by a computational instance of a remote network management platform to create an incident in an incident database structure.

In FIG. 10B, model prompt 1010 is provided to natural language model 704 to produce output 1012. Again, model prompt 1010 requests code in the GLIDE programming language and identifies specific variable names to be used. Output 1012 includes code in GLIDE using variables with those names. This code can also be executed by a computational instance of a remote network management platform, and serves to create an IT ticket in an IT ticketing database structure.

Notably, input parameters 816, which were extracted from question utterances at step 814, are used in step 824. This allows, during runtime, a virtual agent to ask for specific input from a user, allocate variables to store this input, receive input into these variables, and then use the variables to interact with a computing system. Since the variables are provided in model prompts, any of the computing system's pre-established variables can be used. In other words, a custom code snippet can be generated such that it can be seamlessly plugged into and executed in an existing software architecture. Nonetheless, certain complex code generation requests may be split across multiple model prompts for purposes of modularization and performance.

These embodiments provide a technical solution to a technical problem. One technical problem being solved is automated virtual agent rule generation using historical conversation data. In the prior art, there are two main options—having a human manually define rules or having an LLM generate rules with few if any guidelines. However, these techniques are not ideal in practice. Human-defined rules rely on subjective decisions and experiences of human virtual agent designers, which leads to wildly varying outcomes from instance to instance. LLM-generated rules suffer from inaccuracies, hallucinations, and can inadvertently include offensive text. Thus, prior art techniques did little if anything to address the need to generate and deploy effective virtual agents for various uses quickly and at scale.

The embodiments herein overcome these limitations by defining a step-by-step process for virtual agent rule generation using historical conversation data as a basis, while only employing LLMs (or other natural language models) for limited and specific tasks to which they are well-suited (e.g., generating short units of text, summaries, or code). In this manner, rule-based virtual agent generation can be accomplished in a more accurate and robust fashion. This results in several advantages, including faster development and deployment of higher-quality virtual agents. Other technical improvements may also flow from these embodiments, and other technical problems may be solved.

### IX. Practical Considerations and Examples

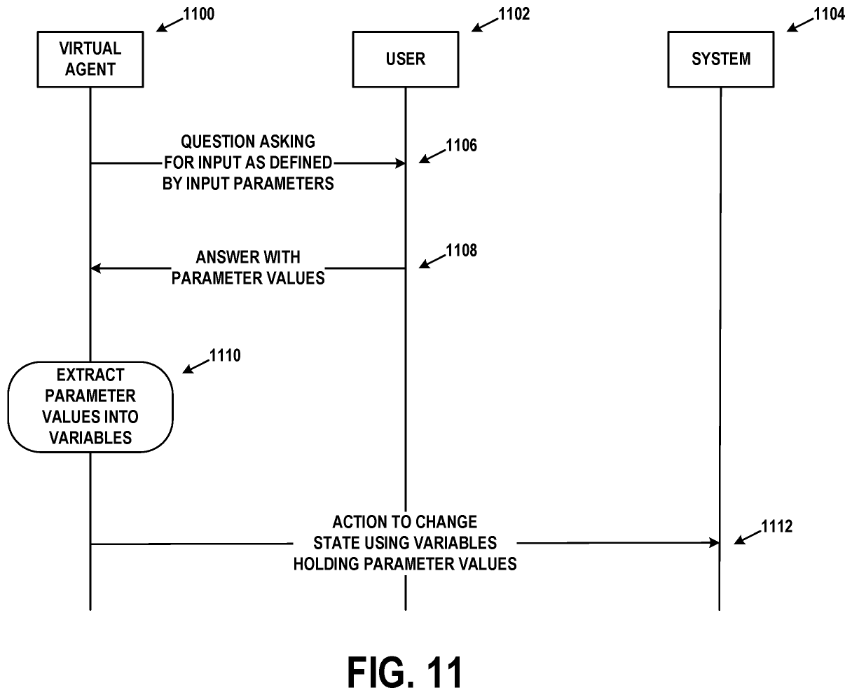

FIG. 11 is a message flow diagram illustrating virtual agent operation during runtime. It is assumed that the virtual agent employs rules generated by the embodiments herein, including use of input parameters as discussed in the context of FIG. 8. Interactions are between virtual agent 1100, user 1102 (which could be a human user or another virtual agent, for example), and system 1104 (which could be a module of a computing system that can change state, such as a database structure).

At step 1106, virtual agent 1100 transmits, to user 1102, a question that asks for input. The question may have been generated by a natural language model and the input may include input parameters (e.g., the name and address of user 1102). At step 1108, user 1102 transmits, to virtual agent 1100, an answer to the question containing parameters values (e.g., “John Smith” and “123 Elm Street, Anytown, USA”). Ideally, user 1102 provides a value for each input parameter in the question. At step 1110, virtual agent 1100 extracts the parameter values from the answer into variables associated with the input parameters (e.g., varName=“John Smith” and varAddress=“123 Elm Street, Anytown, USA”). At step 1112, virtual agent 1100 provides an action to change the state of system 1104 using the content of the variables (e.g., writing the values of varName and varAddress into an entry of a database table). Alternatively, a state change might not occur if the variables are used to read information from memory or long-term storage, for example.

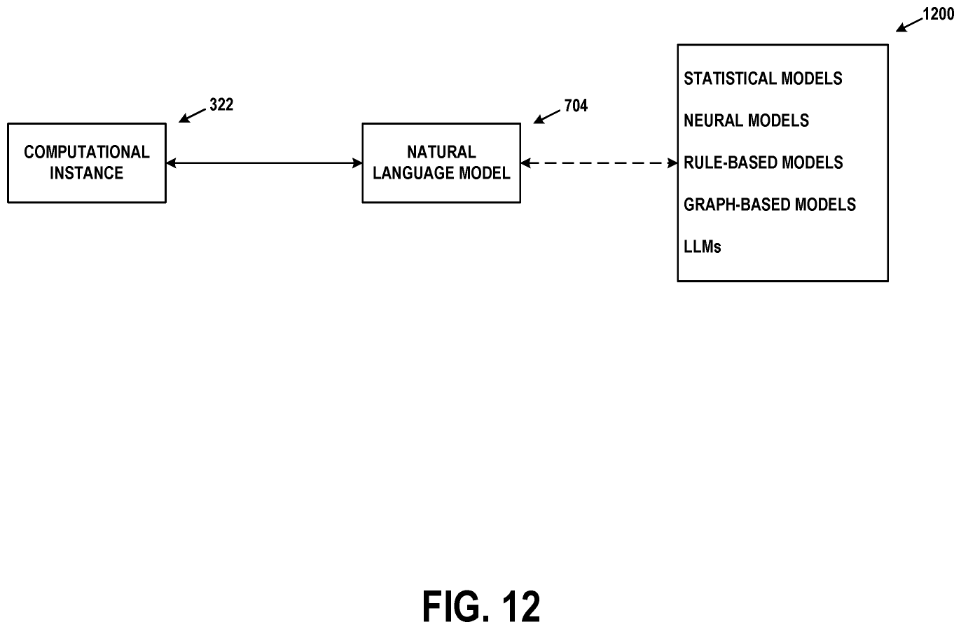

FIG. 12 depicts communication between computational instance 322 and natural language model 704. Computational instance 322 may carry out the embodiments herein to generate rules-based virtual agents. Thus, computational instance 322 may, for time to time, query natural language model 704 for purposes of generating text, summarizing text, generating code, and so on.

As shown, natural language model 704 is used to represent one or more language models 1200 that could be used to respond to these queries. For example, statistical models use statistical methods to analyze text and generate predictions about what words or phrases might come next in a sentence, neural models use neural networks to process and analyze text based on deep learning techniques, rule-based models use a set of predefined linguistic rules to analyze and generate text, graph-based models use structured knowledge representations to analyze and generate text, and LLMs may use extensive layers of neural networks and transformer architectures to generate text. Other models are possible.

Regardless, when a natural language model is referred to herein, it may represent any one of language models 1200, some combination thereof, or a different language model altogether. Further, the embodiments herein may use different ones of language models 1200 in different steps.

### X. Example Operations

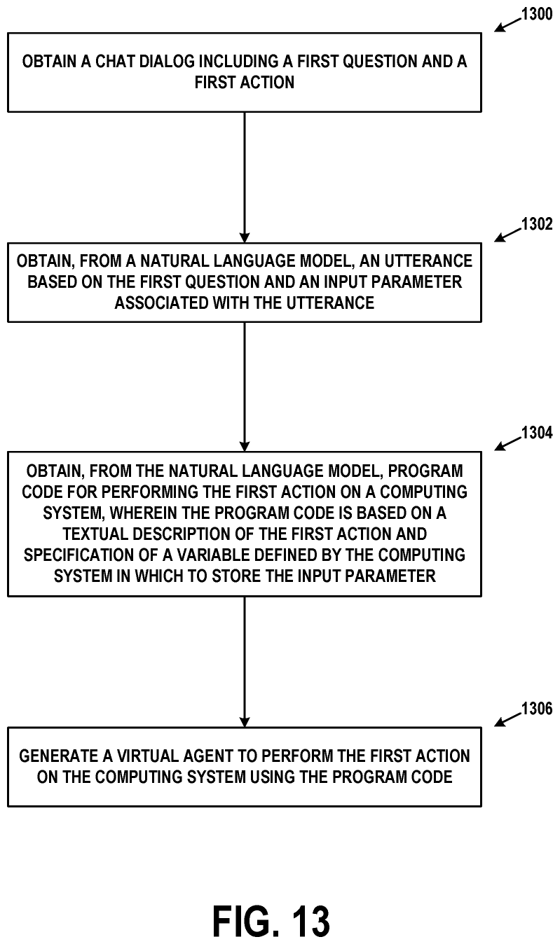

FIG. 13 is a flow chart illustrating an example embodiment. The process illustrated by FIG. 13 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 13 may be simplified by the removal of any one or more of the features shown therein. Further, these embodiments may be combined with features, aspects, and/or implementations of any of the previous figures or otherwise described herein.

Block 1300 may involve obtaining a chat dialog including a first question and a first action. Block 1302 may involve obtaining, from a natural language model, an utterance based on the first question and an input parameter associated with the utterance. Block 1304 may involve obtaining, from the natural language model, program code for performing the first action on a computing system, wherein the program code is based on a textual description of the first action and specification of a variable defined by the computing system in which to store the input parameter. Block 1306 may involve generating a virtual agent to perform the first action on the computing system using the program code.

In some embodiments, the input parameter is extracted from the utterance.

In some embodiments, the chat dialog includes a second question and a second action. Some embodiments may involve: obtaining, from the natural language model, a second utterance based on the second question and a second input parameter associated with the second utterance; obtaining, from the natural language model, second program code for performing the second action on the computing system, wherein the second program code is based on a second textual description of the second action and specification of a second variable defined by the computing system in which to store the second input parameter; and generating the virtual agent to perform the second action on the computing system using the second program code.

Some embodiments may involve determining that the first question is related to the first action, wherein the utterance is obtained based on the determination.

In some embodiments, the natural language model comprises a transformer-based large language model.

Some embodiments may involve, prior to obtaining the utterance, removing machine-generated entries from the chat dialog.

Some embodiments may involve, prior to obtaining the utterance, obtaining, from the natural language model, labels for each respective entry in the chat dialog indicating whether the respective entry is a question or an action.

Some embodiments may involve: asking, by the virtual agent, the first question to a user; receiving, by the virtual agent, an answer to the first question from the user, wherein the answer includes a value for the input parameter; and storing the value in the variable.

In some embodiments, the chat dialog is based on a plurality of recorded chat dialogs between human agents and human users.

In some embodiments, the specification of the variable is provided to the natural language model by way of a textual prompt.

Some embodiments may involve directing the virtual agent to perform the first action on the computing system using the program code.

### XI. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a chat dialog including a first question and a first action;
obtaining, from a natural language model, an utterance based on the first question and an input parameter associated with the utterance;
obtaining, from the natural language model, program code for performing the first action on a computing system, wherein the program code is based on a textual description of the first action and specification of a variable defined by the computing system in which to store the input parameter; and
generating a virtual agent to perform the first action on the computing system using the program code.

2. The method of claim 1, wherein the input parameter is extracted from the utterance.

3. The method of claim 1, wherein the chat dialog includes a second question and a second action.

4. The method of claim 3, further comprising:
obtaining, from the natural language model, a second utterance based on the second question and a second input parameter associated with the second utterance;
obtaining, from the natural language model, second program code for performing the second action on the computing system, wherein the second program code is based on a second textual description of the second action and specification of a second variable defined by the computing system in which to store the second input parameter; and
generating the virtual agent to perform the second action on the computing system using the second program code.

5. The method of claim 1, further comprising:
determining that the first question is related to the first action, wherein the utterance is obtained based on the determination.

6. The method of claim 1, wherein the natural language model comprises a transformer-based large language model.

7. The method of claim 1, further comprising:
prior to obtaining the utterance, removing machine-generated entries from the chat dialog.

8. The method of claim 1, further comprising:
prior to obtaining the utterance, obtaining, from the natural language model, labels for each respective entry in the chat dialog indicating whether the respective entry is a question or an action.

9. The method of claim 1, further comprising:
asking, by the virtual agent, the first question to a user;
receiving, by the virtual agent, an answer to the first question from the user, wherein the answer includes a value for the input parameter; and
storing the value in the variable.

10. The method of claim 1, wherein the chat dialog is based on a plurality of recorded chat dialogs between human agents and human users.

11. The method of claim 1, wherein the specification of the variable is provided to the natural language model by way of a textual prompt.

12. The method of claim 1, further comprising:
directing the virtual agent to perform the first action on the computing system using the program code.

13. A non-transitory computer-readable medium, having stored thereon program instructions that, upon execution by a computing system, cause the computing system to perform operations comprising:
obtaining a chat dialog including a first question and a first action;
obtaining, from a natural language model, an utterance based on the first question and an input parameter associated with the utterance;
obtaining, from the natural language model, program code for performing the first action on the computing system, wherein the program code is based on a textual description of the first action and specification of a variable defined by the computing system in which to store the input parameter; and
generating a virtual agent to perform the first action on the computing system using the program code.

14. The non-transitory computer-readable medium of claim 13, wherein the input parameter is extracted from the utterance.

15. The non-transitory computer-readable medium of claim 13, the operations further comprising:
determining that the first question is related to the first action, wherein the utterance is obtained based on the determination.

16. The non-transitory computer-readable medium of claim 13, the operations further comprising:
prior to obtaining the utterance, removing machine-generated entries from the chat dialog.

17. The non-transitory computer-readable medium of claim 13, the operations further comprising:
prior to obtaining the utterance, obtaining, from the natural language model, labels for each respective entry in the chat dialog indicating whether the respective entry is a question or an action.

18. The non-transitory computer-readable medium of claim 13, wherein generating the virtual agent to perform the first action on the computing system using the program code comprises:
asking, by the virtual agent, the first question to a user;
receiving, by the virtual agent, an answer to the first question from the user, wherein the answer includes a value for the input parameter; and
storing the value in the variable.

19. The non-transitory computer-readable medium of claim 13, wherein the specification of the variable is provided to the natural language model by way of a textual prompt.

20. A system comprising:
one or more processors; and
memory, containing program instructions that, upon execution by the one or more processors, cause the system to perform operations comprising:
obtaining a chat dialog including a first question and a first action;
obtaining, from a natural language model, an utterance based on the first question and an input parameter associated with the utterance;
obtaining, from the natural language model, program code for performing the first action on a computing system, wherein the program code is based on a textual description of the first action and specification of a variable defined by the computing system in which to store the input parameter; and
generating a virtual agent to perform the first action on the computing system using the program code.
